(19) United States
(12) Patent Application Publication
(10) Pub. No.: US 2002/0107597 A1
(43) Pub. Date: Aug. 8, 2002

(54) System and method for defining the construction of a press

(76) Inventor: Juergen Fahrenbach, Aichelberg (DE)

Correspondence Address: CROWELL & MORING. L.L.P., P.O. Box 14300, Washington, DC, 20044-4300, US

(21) Appl. No.: 10/028,986

(22) Filed: Dec. 28, 2001

(30) Foreign Application Priority Data
Dec. 29, 2000 (DE) 100 65 260.3

(51) Int. Cl. G06F 19/00

(52) U.S. Cl. 700/95; 700/160; 700/182

(57) ABSTRACT

A system and method for defining the construction of a press has at least one slide on which at least one part (top tool) of a forming tool is mounted, at least one driving device for driving the slide, and at least one press frame. The construction of the press and the required construction of the driving device are defined by a data processing unit into which data are entered concerning the measurements of a workpiece to be machined, as well as data concerning the force required for machining the workpiece and data concerning the stroke of the slide required for machining the workpiece.

### BACKGROUND OF THE INVENTION

This application claims the priority of Germany, filed Dec. 29, 2000, the disclosure of which is expressly incorporated by reference herein.

The present invention relates to a system for defining the construction of a press.

When constructing or designing a press, it has been customary to build on what is known and to use certain types of presses and driving devices for certain application purposes. This approach, which is customary in the case of individual presses as well as in the case of large-piece or multistation presses has, however, led to the existence of many different types of presses, including related driving devices that are not always used in an ideal manner. Furthermore, this large number of different press types and driving devices makes the selection of the suitable press for the respective workpiece to be machined more difficult.

### SUMMARY OF THE INVENTION

An object of the present invention is, therefore, to provide a system and method of defining the construction of a press by way of which the construction of the press can be defined and adapted to the respective application purpose in a very uncomplicated manner.

According to the invention, this object has been achieved by providing that the press construction and a required construction of the driving device are defined by a data processing unit into which data are entered concerning measurements of a workpiece to be machined, as well as data concerning the force required for machining the workpiece, and data concerning the stroke of the slide required for machining the workpiece.

By using a data processing unit into which the different parameters of the workpiece to be machined can be inputted as data, a simple and simultaneously very reliable possibility is provided for defining the suitable construction of the press, including the construction of the driving device. Particularly, the versatility of the system according to the invention is advantageous, in that only slight changes have to be made on the driving device and/or on the press for relatively similar workpieces.

### BRIEF DESCRIPTION OF THE DRAWINGS

Other objects, advantages and novel features of the present invention will become apparent from the following detailed description of the invention when considered in conjunction with the accompanying drawings.

FIG. 1 is a schematic diagram of the system according to the present invention for defining the construction of a press;

FIG. 2 is a schematic elevational view of a first embodiment of a press defined by the system of the present invention; and

FIG. 3 is a view of a second embodiment of a press defined by the system of the present invention.

### DETAILED DESCRIPTION OF THE DRAWINGS

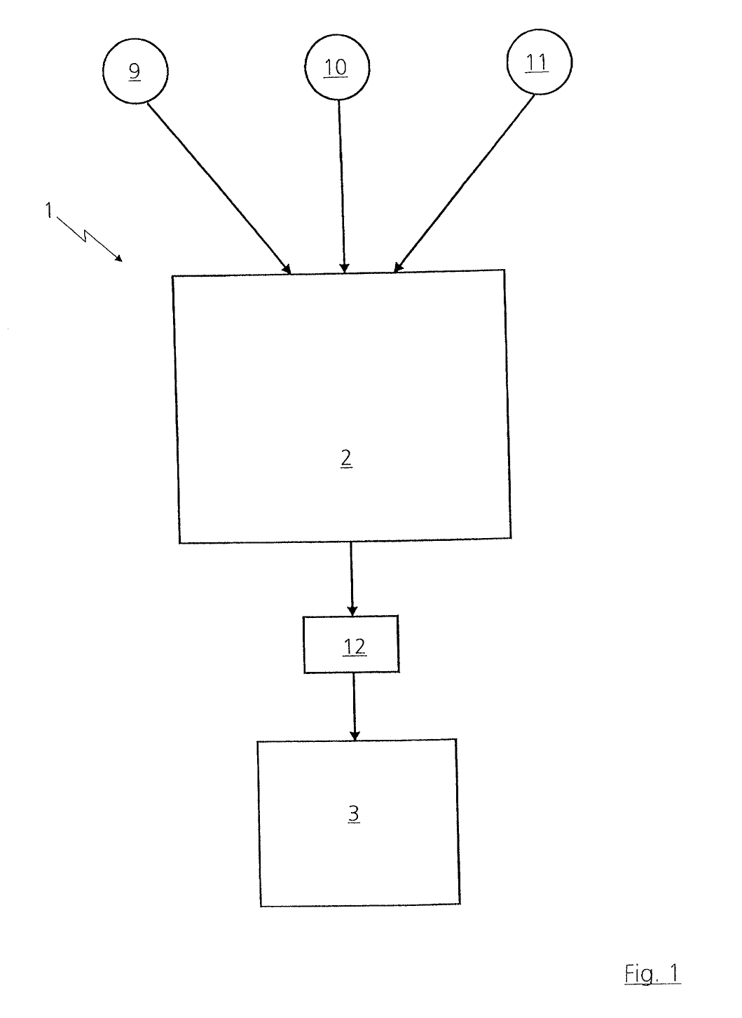

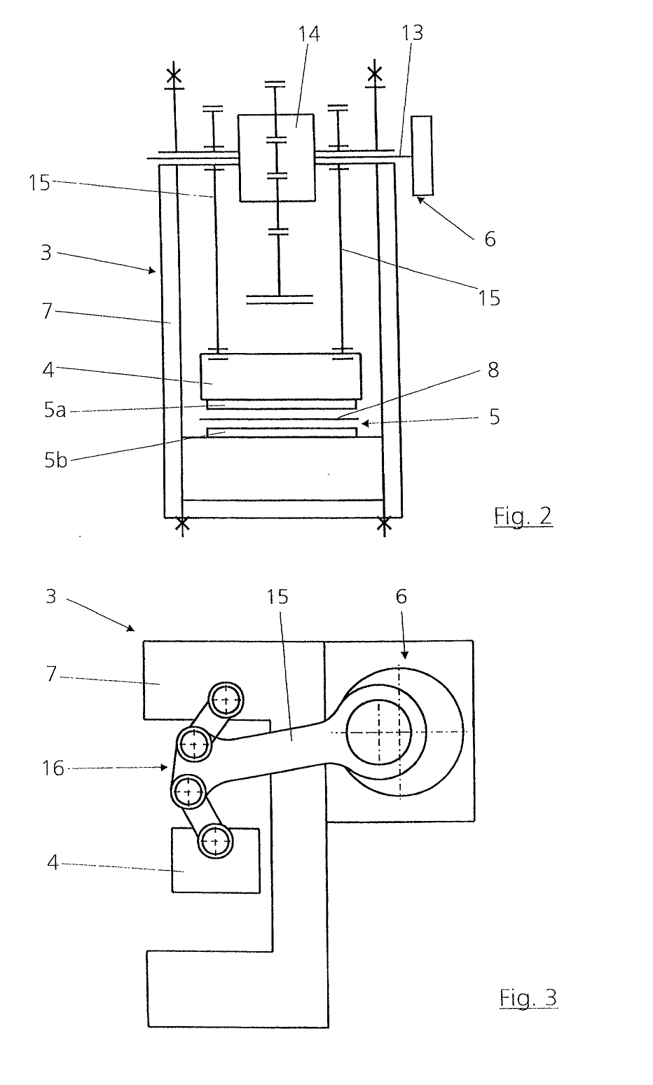

FIG. 1 illustrates a system 1 which has a data processing unit 2 as a central element and is used for defining the construction of a press 3 which is illustrated in different embodiments in FIGS. 2 and 3.

The press 3 according to FIG. 2 has a slide 4 on which a top tool 5a is mounted as part of a forming tool 5. Additional components of the press 3 are a driving device 6 for driving the slide 4 as well as a press frame 7 which accommodates the driving device 6 and the slide 4 and on which a bottom tool 5b is arranged as another part of the forming tool 5. By way of the forming tool 5, a workpiece 8 is produced in a conventional manner.

In order to define the construction of the press 3 and of the driving device 6, various data 9, 10, and 11 are entered into the data processing unit 2, specifically data 9 with respect to the measurements of the workpiece 8 to be machined; data 10 which relate to forces required for machining the workpiece 8; and data 11 concerning the stroke of the slide required for machining the workpiece 8. The data processing unit 2 defines the construction of the press 3 and of the pertaining driving device 6 from these data 9, 10 and 11. For displaying the defined construction of the press 3, a CAD program 12 is connected to the output side of the data processing unit 2. As a parametrized system, this CAD program 12 is capable of automatically preparing the construction drawings.

Thus, for example, the press 3 illustrated in FIG. 2 can be defined which is constructed as an eccentric press and whose driving device 6, for example, an electric motor, drives a planetary gear 14 by way of a drive shaft 13. In this case, the slide 4 is connected by two connecting rods 15 with the planetary gear 14, and the planetary gear 14 is arranged between the two connecting rods 15. The driving device 6 is situated inside the press 3, but if the press 3 is constructed as a knuckle joint press, the driving device 6 may be arranged on the lateral wall of the press 3.

Another press 3 which can be defined by the present invention is illustrated in FIG. 3. In this embodiment, the slide 4 is driven by the driving device 6 by way of a knee link element 16. The knee link element 16 can be connected by way of at least one connection element but, as in the illustrated embodiment of the knee link element 16, by way of two connection elements, with another knee link element which is also mounted on the slide 4. Also in that case, the driving device 6 has the planetary gear 14.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. System for defining a press construction, having at least one slide on which at least one part of a forming tool is mounted, at least one driving device for driving the at least one slide, and at least one press frame, wherein the press construction and a required construction of the driving device are defined by a data processing unit into which data are entered concerning measurements of a workpiece to be machined, as well as data concerning the force required for machining the workpiece, and data concerning the stroke of the slide required for machining the workpiece.

2. System according to claim 1, wherein
a defined construction of the press is an output of a CAD program.

3. System according to claim 2, wherein
the CAD program is configured to prepare construction drawings.

4. System according to claim 1, wherein
the driving device is configured to drive a planetary gear via a drive shaft, the slide being operatively connected with the planetary gear by at least two connecting rods and the planetary gear being operatively arranged between at least two connecting rods.

5. System according to claim 4, wherein
a defined construction of the press is an output of a CAD program.

6. System according to claim 5, wherein
the CAD program is configured to prepare construction drawings.

7. System according to claims 1, wherein
the slide is arranged to be driven by the driving device via at least one knee link element.

8. System according to claim 6, wherein
the slide is arranged to be driven by the driving device via at least one knee link element.

9. System according to claim 7, wherein
the at least one knee link element is operatively connected by at least one connection element with another knee link element mounted on the slide.

10. System according to claim 9, wherein two connection elements are provided for operatively connecting the two knee link elements.

11. Method for determining a press construction having at least one slide on which at least one part of a forming tool is mounted, at least one driving device for driving the at least one slide, and at least one press frame comprising
(a) entering workpiece measurements data into a data processing unit,
(b) entering workpiece machining force data into the data processing unit, and
(c) entering slide stroke data for machining a workpiece into the data processing unit, wherein
the entering of the data on (a), (b) and (c) defines the press construction and a required driving device construction.

12. Method according to claim 11, wherein the defined press construction is an output of a CAD program.

13. Method according to claim 12, wherein construction drawings are prepared by the CAD program.

14. Method according to claim 11, wherein the driving device is configured to drives a planetary gear via a drive shaft, the slide being operatively connected with the planetary gear by at least two connecting rods and the planetary gear being operatively arranged between at least two connecting rods.

15. Method according to claim 14, wherein the slide is arranged to be driven by the driving device via at least one knee link element.

16. Method according to claim 15, wherein the at least one knee link element is operatively connected by at least one connection element with another knee link element mounted on the slide.
